(19) United States
(12) Patent Application Publication
(10) Pub. No.: US 2019/0353931 A1
(43) Pub. Date: Nov. 21, 2019

(54) BRACKET ASSEMBLY FOR PLACEMENT AND ALIGNMENT OF A FLAT RING WITHIN A CYLINDRICAL SOCKET

(71) Applicant: Peter Bradford Krenesky, Vancouver, WA (US)

(72) Inventor: Peter Bradford Krenesky, Vancouver, WA (US)

(21) Appl. No.: 15/983,095

(22) Filed: May 18, 2018

(51) Int. Cl. G02C 11/04; F21V 19/00

(52) U.S. Cl. CPC G02C 11/04; F21Y 2115/10; F21V 19/003

(57) ABSTRACT

The present invention comprises a bracket assembly that holds a lens and a circuit board with LED components therein, wherein the bracket assembly comprises an upper bracket, a protective cover, and a lower bracket. The bracket assembly is disposed between a goggle socket and a goggle lens cap such that the goggle socket is directly adjacent to the lower bracket and the goggle lens cap is directly adjacent to the upper bracket. The lens is disposed between the circuit board and the lower bracket such that the lens is biased toward the goggle socket. The position of the lens prevents reflections from the LED components. Additionally, the position of the lens allows it to be composed of light impeding material without impeding the emission of light from the LED components. Additionally, the circuit board is recessed within the goggle socket to increase the angular aperture of the goggles.

### FIELD OF THE INVENTION

The present invention relates generally to a bracket assembly. More particularly, the present invention is directed to a bracket assembly for use in eye goggles.

### BACKGROUND OF THE INVENTION

Various types of novelty eyewear such as costume goggles are known in the art. Some novelty eyewear comprises one or more lighting components (e.g., LEDs) for illuminating in low light environments. These devices include lighting components that are directly placed over the lens without leaving a centrally located aperture such that there is no line of vision when worn. Alternatively, circuit boards that are connected to the lighting components also restrict the wearer's vision. Additionally, the lighting components are generally placed behind the lens. In this way, it is impractical to wear the goggles over the eyes because the brightness from the reflection of the lights can be extremely distracting and impair the wearer's vision. Thus, these types of eyewear are worn on the wearer's forehead and are not functional to be worn over the eyes. Additionally, the lens must allow light to pass through it or it would not be visible. In this regard, the invention described herein addresses these problems.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

In some embodiments, the present invention comprises a bracket assembly that is configured to hold a lens and a circuit board with LED components therein, wherein the bracket assembly comprises an upper bracket, a protective cover, and a lower bracket. The bracket assembly is disposed between a goggle socket and a goggle lens cap such that the goggle socket is directly adjacent to the lower bracket and the goggle lens cap is directly adjacent to the upper bracket. The lens is disposed between the circuit board and the lower bracket such that the lens is biased toward the goggle socket. The position of the lens prevents reflections from the LED components. Additionally, the position of the lens allows it to be composed of light impeding material without impeding the emission of light from the LED components. Additionally, the circuit board is recessed within the goggle socket to increase the angular aperture to allow a wearer to see through the goggles.

### BRIEF DESCRIPTION OF THE DRAWINGS

FIG. 1 depicts an exploded view of the components of a goggle.

FIG. 2 shows an exploded view of the bracket assembly.

FIG. 3A shows a side planar view of the lower bracket.

FIG. 3B shows a top down view of the lower bracket.

FIG. 3C shows a bottom up view of the lower bracket.

FIG. 4A shows a top perspective view of the lower bracket.

FIG. 4B shows a bottom perspective view of the lower bracket.

FIG. 5A shows a side planar view of the protective cover.

FIG. 5B shows a top down view of the protective cover.

FIG. 5C shows a bottom up view of the protective cover.

FIG. 6A shows a side planar view of the upper bracket.

FIG. 6B shows a top down view of the upper bracket.

FIG. 6C shows a bottom up view of the upper bracket.

FIG. 7A shows a top perspective view of the upper bracket.

FIG. 7B shows a bottom perspective view of the upper bracket.

FIG. 8 shows a perspective view of the circuit board.

FIG. 9 shows a circuit diagram of the circuit board as connected to a microcontroller and a power supply.

### DETAILED DESCRIPTION OF THE INVENTION

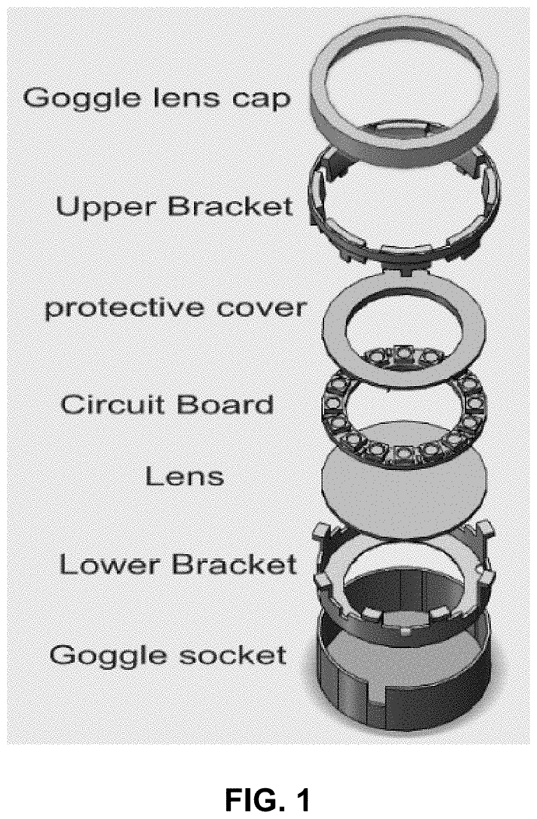

Referring now to FIG. 1, there is shown an exploded of the components of a goggle. The goggle comprises a lens cap, a bracket assembly, a circuit board, a lens, and a goggle socket, wherein the bracket assembly comprises an upper bracket, a protective cover, and a lower bracket. Each of the components comprises a circular or annular shape having a central aperture or opening with the exception of the lens. In this way, the components are configured to enable a wearer to see through the lens of the goggle.

The goggle socket is configured to retain the bracket assembly, the circuit board, and the lens therein. In this regard, the goggle socket comprises a cylindrical housing member that is shaped and dimensioned to hold the bracket assembly, the circuit board, and the lens therein. Additionally, the lens cap is positioned over the aforementioned components to prevent the components from escaping the goggle socket. Each of the upper bracket and the lower bracket of the bracket assembly comprises tabs in a pattern so that they align when the brackets are assembled. The lower bracket is configured to support the lens thereon.

The circuit board is disposed between the lens and the protective cover so as to reduce distraction to the wearer while the LEDs on the circuit board are in operation. The positioning of the circuit board within the goggle socket provides a wider angular aperture to allow the wearer to properly see through the goggle when worn. In some embodiments, the lens can be positioned behind the circuit board such that the lens is biased toward the goggle socket. This can prevent the LEDs to reflect into the wearer's eyes. Additionally, the placement of the lens in this way allows the circuit board to emit light outward and away from the socket and wearer without obstruction, interference, impedance, or other effect from the lens. The goggle lens cap fits of the entire bracket assembly and can directly contact the goggle socket, such that the entire assembly forms a substantially cylindrical shape. Because the bracket assembly, the circuit board, the lens cap, the circuit board, and the goggle socket comprise a central aperture or opening, the lens is unobstructed.

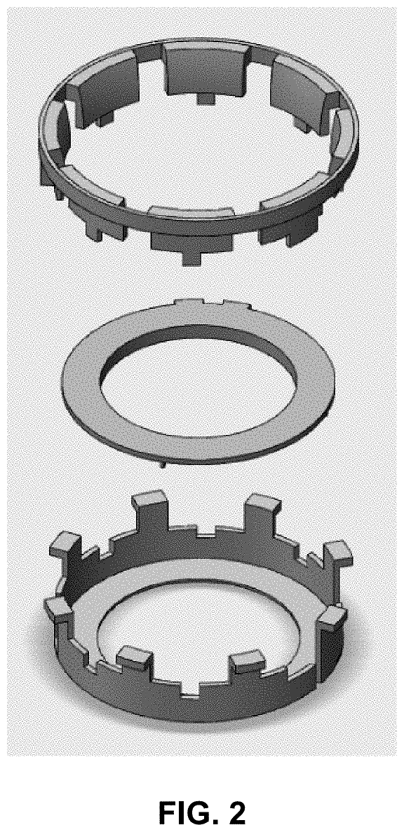

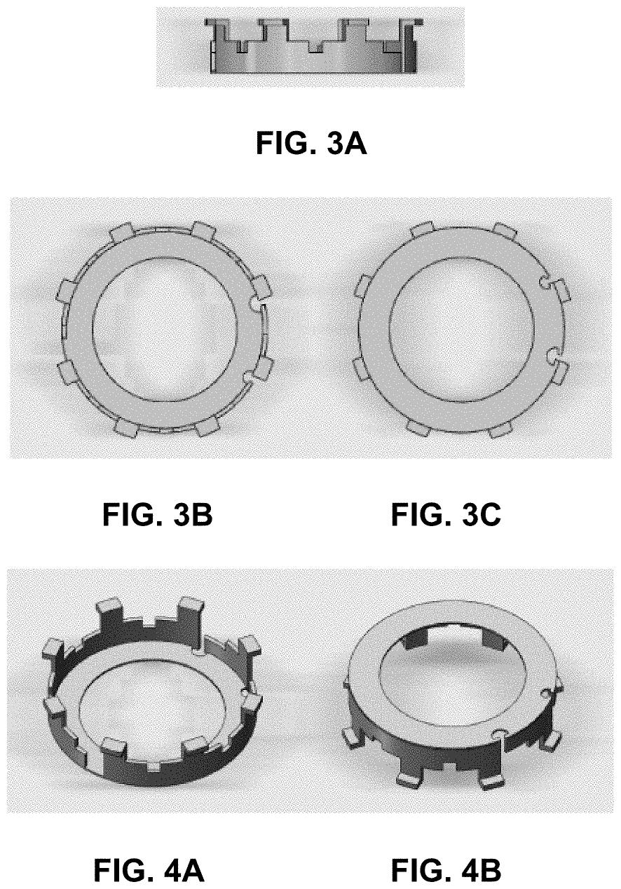

Referring now to FIG. 2, there is shown an exploded view of the lower bracket, upper bracket, and protective cover of the bracket assembly. Each of the lower bracket, upper bracket, and protective cover comprises an annular structure so as to leave a central aperture or opening. The lower bracket comprises a flat circular frame member comprising an upward flange having a plurality of tabs extending upward therefrom, wherein the flange is disposed around the outer perimeter of the circular frame member, as depicted in FIGS. 3A through 4B.

The tabs are separated at regular intervals and comprise a substantially rectangular shape. Additionally, the upper end of each of the tabs comprises a flange that extends outward and away from the opening. The upward flange also comprises a plurality of rectangular cutouts, wherein each cutout is disposed between the tabs. Further, the circular frame comprises a pair of cutouts that extends toward the upward flange. The cutouts are configured to allow circuit board wires to extend therethrough. The lower bracket is configured to support the circuit board therein while supporting the bracket assembly within the goggle socket.

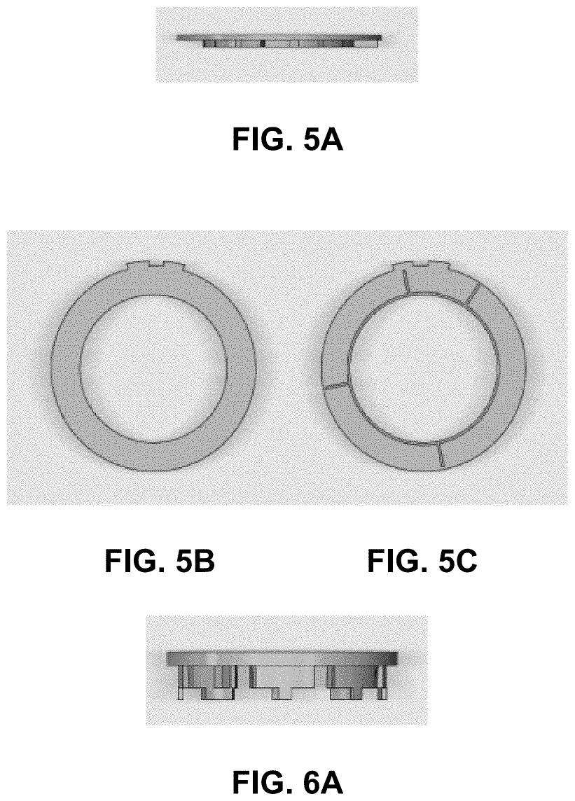

The protective cover comprises a flat circular frame member having a flange that spans the inner perimeter of the frame member, as depicted in FIGS. 5A through 5C. It is noted that the flange is configured to only align to the lower bracket. The frame member is configured to fit within the lower bracket frame member. The flange comprises a pair of rectangular tabs that extends outward from the outer perimeter of the frame member. Additionally, the frame member comprises a plurality of legs that extend downward from the underside thereof so as to align with the circuit board. In the illustrated embodiment, the legs do not extend beyond the flange.

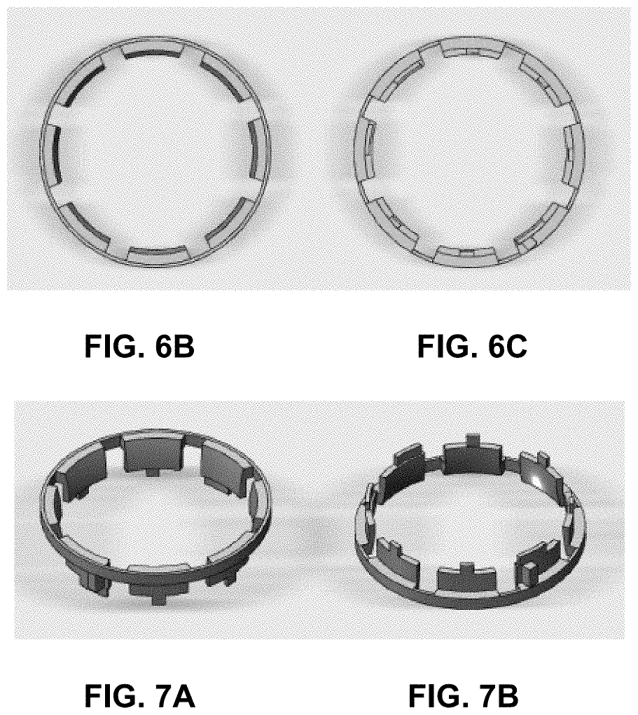

The upper bracket comprises a circular frame member having a plurality of tabs extending downward therefrom, wherein the tabs are disposed around the inner perimeter of the frame member, as depicted in FIGS. 6A through 7B. Each of the tabs comprises a rectangular shape that is separated at regular intervals. Additionally, one or more tabs comprises an extension member that extend beyond the lower end of the tab. The extension member can be centrally located on the tab. Further, one or more tabs comprises horizontal tabs in lieu of the extension member, wherein the horizontal tabs hold the protective cover in place.

In the illustrated embodiment, the circular frame member further comprises a side tab that is directly adjacent to one of the tabs. Each of the tabs, extensions, and the side tab of the upper bracket is configured and positioned to fit between the tabs disposed on the lower bracket. Further, the side tab enables the upper bracket to properly align within the goggle socket.

In operation, the protective cover is disposed between the upper frame and the lower frame. In this regard, the upper frame, the protective cover, and the lower frame are positioned so as to properly align the tabs and/or cutouts disposed on the upper frame, the protective cover, and the lower frame. The tabs and/or cutouts are disposed so as to align the bracket assembly only in a single position, preventing the bracket assembly from moving unintentionally. When the bracket assembly is aligned properly, it is configured to also align with the circuit board within the goggle socket. In this way, the bracket assembly does not require any fasteners or adhesives. Instead, it relies on pressure from the goggle's lens cap as it is tightened onto the goggle socket to stay secured in place.

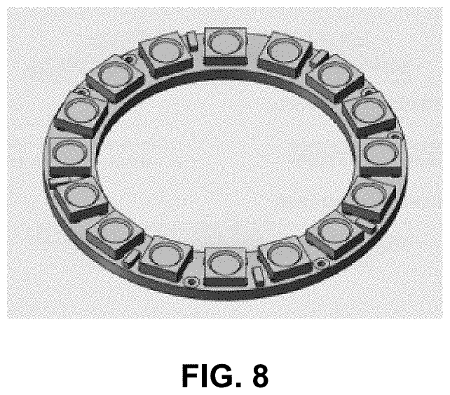

The bracket assembly allows a circuit board to be placed and aligned within the goggle socket. The circuit board with LED components are depicted in FIG. 8. The circuit board comprises a circular frame member having a centralized aperture or opening. The frame member includes a plurality of LEDs separated at regular intervals. Additionally, the frame member can comprise one or more tabs or protrusions extending therefrom, wherein the tabs or protrusions comprise other electronic components (e.g., resistors) necessary to operate the LED components. The tabs or the protrusions are configured to properly align the circuit board within the bracket assembly. The circuit board comprises a low profile in order to reduce the bulkiness of the goggles.

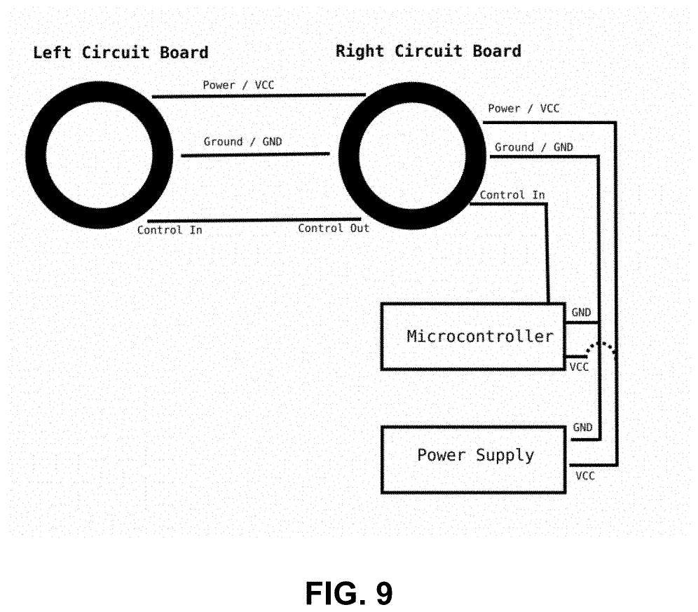

Referring now to FIG. 9, there is shown a circuit diagram of the circuit board. The left circuit board and the right circuit board are wired together. The wires from the circuit boards pass through the side of the bracket assembly and through the side of the goggle socket. One of the circuit boards is connected to a microcontroller or another processing unit that is configured to operate the LEDs disposed on the circuit board. The microcontroller can be programmed to illuminate the LEDs in specific patterns or animate the LEDs. Additionally, one of the circuit boards is operatively connected to a power supply, wherein the power supply comprises batteries. In the illustrated embodiment, the right circuit board is connected to the microcontroller and the power supply. The wires from the microcontroller pass through the bottom of the bracket assembly and are routed along the inside edge of the goggle socket to a headband attached thereto. In an exemplary embodiment, the microcontroller and the power supply are removably attached to the headband.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A bracket assembly, comprising:
an upper bracket;
a lower bracket;
a circuit board comprising LED components;
a protective cover and said circuit board disposed between said upper bracket and said lower bracket;
each of said upper bracket, said lower bracket, said circuit board, and said protective cover comprising a circular frame with a centralized aperture.

2. The bracket assembly of claim 1, further comprising a lens, wherein said lens is directly adjacent to said lower bracket and said circuit board, wherein the position of said lens prevent reflections to a wearer's eyes.

3. The bracket assembly of claim 1, further comprising a lens, wherein said lens is directly adjacent to said lower bracket and said circuit board, wherein the position of said lens allows light to be emitted without obstruction, impedance, interference, or any effect from said lens.

4. The bracket assembly of claim 1, wherein said circuit board is recessed in a goggle socket to maximize angular aperture.

5. The bracket assembly of claim 1, further comprising a goggle socket and a goggle lens cap, wherein said goggle socket is directly adjacent to said lower bracket and said goggle lens cap is directly adjacent to said upper bracket.

6. The bracket assembly of claim 1, wherein said upper bracket and said lower bracket comprises a plurality of tabs that can be aligned to fit said upper bracket, said lower bracket, and said circuit board together in a single position.
